(19) United States
(12) Patent Application Publication
(10) Pub. No.: US 2015/0375911 A1
(43) Pub. Date: Dec. 31, 2015

(54) Device for Opening and Re-Closing Food-Containing Packages

(71) Applicant: SIG TECHNOLOGY AG, Neuhausen am Rheinfall (CH)

(72) Inventor: Mathias STIRN, Dresden (DE)

(21) Appl. No.: 14/767,356

(22) PCT Filed: Jan. 24, 2014
(86) PCT No.: PCT/EP2014/051441

§ 371 Date: Aug. 12, 2015

(30) Foreign Application Priority Data
Feb. 15, 2013 (DE) 10 2013 101 526.3

(51) Int. Cl. B65D 51/24; B67B 7/46; B67D 3/00; B65D 39/08; B65D 47/06

(52) U.S. Cl. CPC B65D 51/243; B65D 39/08; B65D 47/06; B67D 3/0061; B67B 7/30

(57) ABSTRACT

A device for opening and re-closing food-containing packages includes a pouring element with a circumferential flange for fastening to the package and a neck for pouring, as well as a cutting element, which is arranged inside the neck and has a plurality of teeth, which are arranged around the circumference and directed towards the package, and a screw cap, the cutting element cutting a pouring opening into the composite film material as a result of a rotational movement of the screw cap when the package is opened for the first time. The teeth of the cutting element have a steep gradient at the tip thereof, a shallower gradient at the flanks thereof and a steep gradient again at the bases thereof.

The invention relates to a device for opening and re-closing food-containing packages, in particular composite cardboard/plastic packages, having a pouring element with a circumferential flange for fastening to the package and a neck for pouring, as well as a cutting element, which is arranged inside the neck and has a plurality of teeth, which are arranged around the circumference and directed towards the package, and a screw cap, the cutting element cutting a pouring opening into the composite film material as a result of a rotational movement of the screw cap when the package is opened for the first time.

Opening and pouring devices for food packages, for example drinks packages, have been known for a long time in a variety of configurations. They are always based on an interaction with the package to be opened, and the packages provided with such opening and pouring elements to this end often have a prepared weak point to make the opening process easier. This can be a mechanical line of weakness in the composite material or else what is known as a prelaminated hole, with which a pouring opening is already punched into the cardboard carrier material and then laminated on both sides with corresponding plastic and where appropriate other layers.

The configuration of the geometry and the number of teeth of known devices differs as much as the respective cutting kinematics. For instance, it is known from JP 11-171 233 A to use teeth of different heights to push the tooth tips and bases to different depths into the packaging material during an axial cutting movement and in this manner reduce the opening forces.

EP 1 396 435 A1 discloses a re-closable opening device of the above-mentioned type, with which the opening movement takes place in a helical manner, a sharpened cutting edge and subsequent piercing teeth of different heights being provided.

EP 1 795 456 A1 discloses a similar pouring element, which has sharpened cutting edges with different cutting faces. Flat, toothless sections are situated between the cutting teeth.

It is also already known (DE 10 2004 040 928 A1) to select the tooth geometry to be such that the teeth have a pointed tip and the cutting edge between the individual teeth becomes increasingly flatter and the teeth merge horizontally into each other.

Finally, it is known from DE 10 2010 040 825 A1 to use a cutting tooth and following teeth of graduated height, shavings-holding spaces being present between the teeth in order to move the cut-away packaging material in the pouring opening region during the helical screw movement.

Proceeding from this, the present invention is based on the object of reducing further still the opening forces necessary for opening food packages for the first time and distributing them as uniformly as possible throughout the opening process. Furthermore, a simple structure that is as flat as possible and a lightweight design of the pouring elements should be achieved in order to increase their cost-effectiveness further.

To achieve this object, it is provided in a device having the features of the preamble of claim 1 for the teeth of the cutting element to have a steep gradient at the tip thereof, a shallower gradient at the flanks thereof, and again a steep gradient at the base thereof.

The invention has recognised that the particular shaping of the tooth geometry in terms of its gradient, that is, the slope of its flanks, produces faster, more uniform piercing of the film material and likewise faster and safer cutting through with a relatively small advance movement.

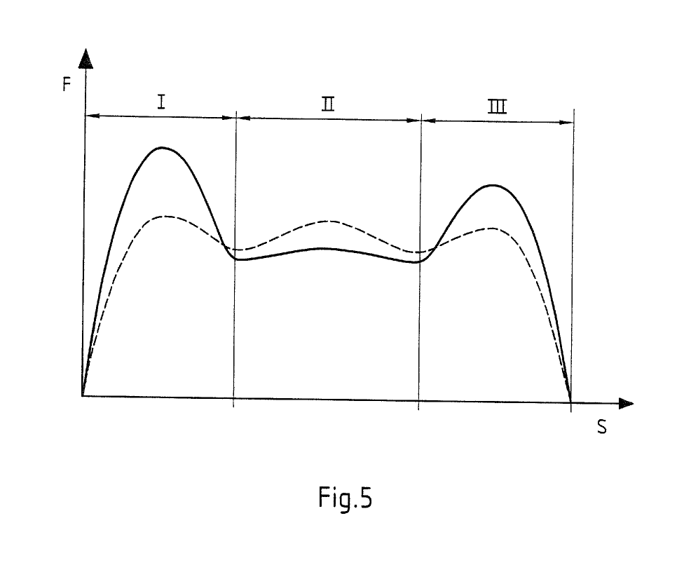

In particular, the force to be applied during piercing, cutting and cutting through plays a particular role for the cutting. The opening process can be divided into three phases. These are shown graphically in FIG. 5, in which the force F to be applied is applied over the section s.

The solid line shows the “conventional” force profile of a cutting element formed as a cutting ring during the opening process, the cutting ring being provided with uniform (triangular) teeth. The dashed curve shows the force profile during the opening process with a device according to the invention.

In Phase I, the “piercing force” is considerably reduced by the tooth shape according to the invention. In Phase II, the cutting drag decreases; in this range the force is slightly more than that of an opening device with conventional tooth shapes (triangles). “Cutting drag” means the ratio of tangential to normal relative speed of material being processed and the working member. The new configuration of the cutting element with the particular tooth shape considerably reduces the “through-cut force” too, as can be seen in Phase III. It can clearly be seen that in all three phases virtually the same amount of force has to be applied to carry out the opening process. This means that the consumer, when uniformly unscrewing the screw cap, requires a very uniform application of force after a short time in order to expose the pouring opening in the packaging material.

The three phases correspond to the different gradients of the teeth: the almost needle-like tooth tips produce point-like piercing with reduced force for each tooth (Phase I). On further movement, the gradient (slope) of the tooth flank decreases (Phase II), and finally the again steep gradient ensures clean cutting through of the cut opening path for cutting through (Phase III). The contour of each individual tooth (steep gradient for piercing; reduced gradient for cutting; steep gradient for cutting through) results in a particularly clean cut, even with particularly elastic composite film.

According to a further configuration of the invention, the teeth of the cutting element are arranged directly adjacently to each other, so that their cutting edges touch. This configuration is particularly expedient, since it results in particularly fast cutting through of the films. The sharpened tooth flanks can in this case extend as far as the tooth base, where the adjacent teeth already touch.

According to a further teaching of the invention, the number of teeth of a cutting element is between 10 and 20 and preferably between 15 and 20. The relatively high number of teeth means that the piercing force is distributed uniformly over the circumference, since perforations are first produced along the opening line.

In a further configuration of the invention, it is provided for the tooth flanks to be formed sharpened. In this case, both tooth flanks can be compared to a knife blade, which can be sharpened on either one or both sides.

According to a further configuration of the invention, the contour of the tooth flanks has arcs in the region of the shallower gradient. These arcs in the region of shallower gradient also reduce the cutting forces by temporarily increasing the cutting drag owing to the “sawtooth shape”.

According to a further configuration of the invention, it is provided for the cutting element to have a region without teeth. This reliably ensures that the cut-away packaging material of the pouring opening remains connected to the rest of the packaging composite and thus cannot fall into the product.

According to a further teaching of the invention, the tooth flanks of each tooth are particularly preferably formed symmetrically. This applies to the geometry both of the tooth flanks and of the front and rear of the tooth.

A further configuration of the invention provides for the tooth flanks of each tooth to be formed inclined in the cutting direction. In this manner, the cutting process can be adapted optimally to the respective opening situation.

So that the membrane consisting of composite film to be detached presents as little resistance as possible to the teeth when a prelaminated hole is present, a further configuration of the invention provides for the teeth to have a low thickness. This means that only a small cutting width is required. With such a configuration, it can be advantageous for the teeth to be provided with longitudinal ribs to reinforce them.

According to a further teaching of the invention, all the teeth have the same height. This is particularly expedient, since the penetration of the plastic material takes place simultaneously during the piercing process and the distances between the perforations are of equal size.

A further configuration of the invention provides for all the teeth to have the same geometry. This is of particular advantage not only in terms of a favourable configuration of the injection-moulding die used, but also in terms of a lower installation height of the device.

In a further teaching of the invention, it is provided for guiding means between the neck and the cutting element to guide the movement of the cutting element. These guiding means can be webs, cams and/or threads or threaded sections. Corresponding arrangements or sequences of webs, cams or threaded sections define the opening movement, which can be composed of a purely axial (piercing) movement, of a rotational (cutting) movements and of the superimposition thereof.

A further configuration of the invention provides for a functional connection to be achieved between the cutting element and the screw cap by means of corresponding actuation elements. Such a configuration is particularly expedient, since a single movement of the user, namely the unscrewing of the lid, is sufficient also to move the cutting element inside the device in a translational and/or rotational manner in order to carry out the opening process.

The invention is explained in more detail below with the aid of a drawing showing only one preferred exemplary embodiment. In the drawing,

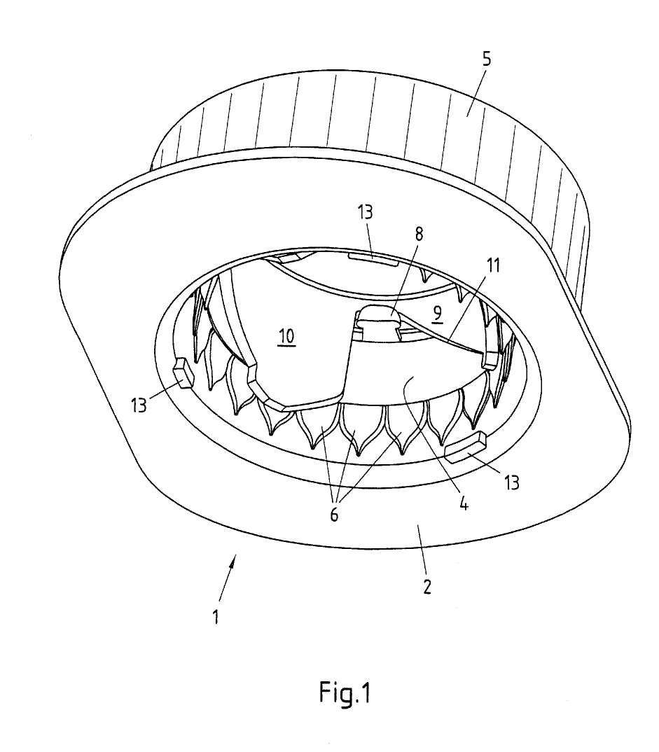

FIG. 1 shows an embodiment of a device according to the invention in the applied state, in a perspective view from below,

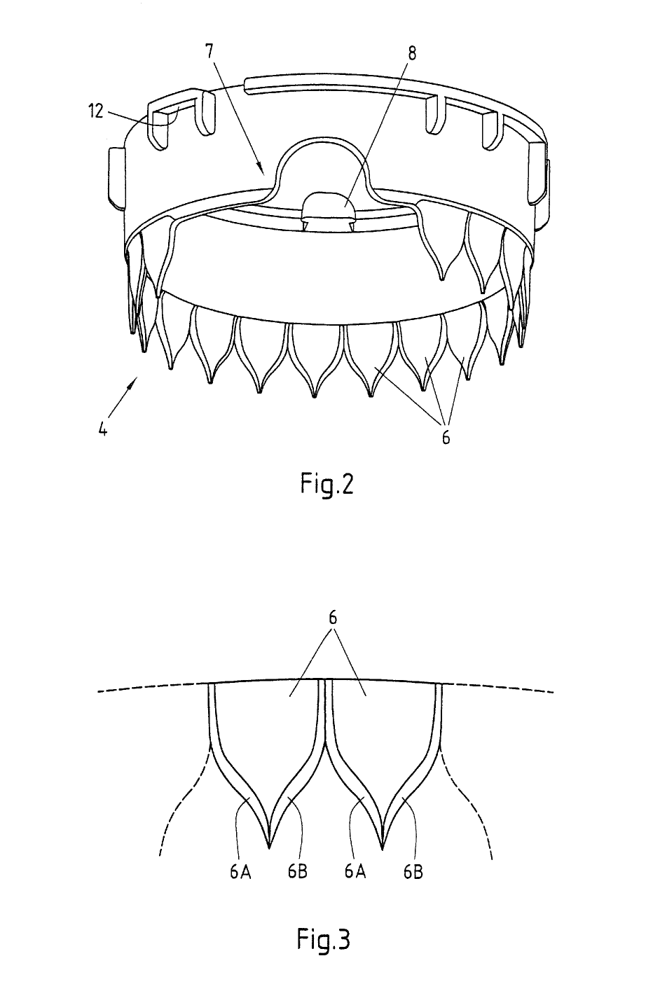

FIG. 2 shows a single cutting element of the device in a perspective view,

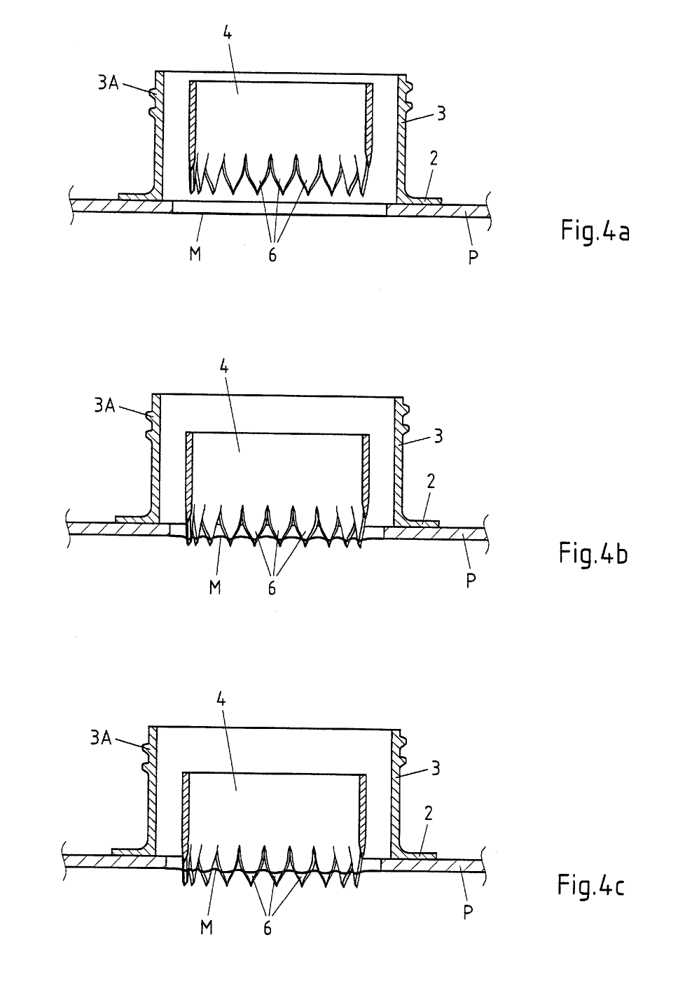

FIG. 3 shows two teeth of the cutting element in an enlarged diagram, and

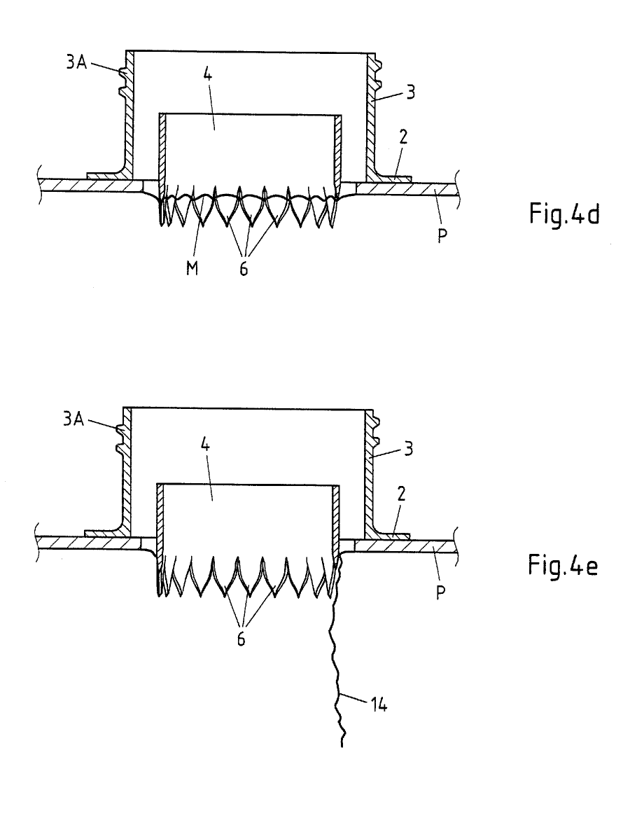

FIGS. 4a-4e show a schematic diagram of the opening process of the cutting element through the composite film.

FIG. 1 shows a device according to the invention in the applied state. A pouring element 1 is provided with a circumferential flange 2, which is applied to a drink package by its visible underside when the pouring element 1 is applied over a “prelaminated hole”. The pouring element has an upwardly extending tube-shaped neck 3, which cannot be seen in FIG. 1, since it is covered by the inside cutting element 4, which is formed as a cutting ring, and by a screw cap 5, which is placed on top.

For a better overview, the cutting ring of the cutting element 4 is shown by itself in FIG. 2. Here, a plurality of teeth 6 can be seen, which are arranged around the circumference of the cutting ring, point downwards and are all identical in the preferred exemplary embodiment shown. FIG. 3 shows another enlargement of two teeth 6, in which it can be seen that the respective tooth flanks 6A and 6B of each individual tooth 6 first have a very steep gradient, that is, a steep slope, at the tooth tip, then a shallower gradient and again a steep gradient in the region of the tooth base. It can be seen that, owing to the immediately adjacently arranged teeth 6, the adjacent flanks 6A and 6B run as far as the tooth base, in order in this manner to achieve an even better cutting effect.

It is further apparent from FIG. 2 that the cutting element 4 has a region 7 without teeth. This configuration ensures that the piece of film cut away from the pouring opening is not completely detached from the composite package, but remains connected to the composite package by means of a sufficient “bridge”, so that it does not obstruct the pouring opening and thus hinder the pouring process.

FIG. 2 further shows that a drive element 8 inside the cutting element projects radially inwards in order to achieve a functional connection to the screw cap 5 together with drive elements 9 and 10 provided inside the screw cap 5. The flank 11 of the curtain of the drive element 9 projecting from the interior of the screw cap 5 provides for an opening movement of the cutting element 4 when the screw cap 5 is unscrewed. The drive elements 9 and 10, which are formed as “fins”, further serve to clear the pouring opening by shifting the film material into the toothless region 7 of the cutting element 4. When the screw cap 5 is screwed on again, the cutting element 4 is pushed down again as far as an end position, in which stops 12, which are arranged around the outer circumference of the cutting element 4, interact with corresponding projections 13 inside the flange 2 and fix the cutting element 4.

The entire opening process is then shown schematically in FIGS. 4a to 4e. An opening device can be seen, which is sealed onto a package P, only part of which is shown and which is provided with a film membrane M in the region of a prelaminated hole, of which opening device only the flange 2 and the neck 3 can be seen in the cutting sequence shown.

In the applied position (FIG. 4a), the cutting element 4, which is mounted by guide means (not shown) between the cutting element 4 and the neck 3, is situated inside the neck 3.

Unscrewing of the screw cap causes the teeth 6 to pierce into the film membrane M in a defined manner, as shown in FIG. 4b, which corresponds to Phase I.

After the first piercing movement, a cutting-open takes place, as shown in FIG. 4c, in which, as mentioned, the uniform introduction of force is improved by a changed cutting drag owing to the particular shape of the tooth geometry (Phase II).

Finally, it can be seen in FIG. 4d that the cutting element 4 has now penetrated so far into the package interior that the teeth have almost completely cut through the membrane. After the membrane has been cut through (Phase III) over approximately 300° of the circumference, the pouring opening is exposed and the film residue 14 can be clamped to the side by further penetration of the cutting element 4, in order to achieve reliable pouring through a free pouring opening.

The invention is not limited to the exemplary embodiment shown, but can be extended to various configurations without departing from the fundamental concept of the invention. To this end, further preferred configurations are provided in the subclaims.

1. Device for opening and re-closing food-containing packages (P), in particular composite cardboard/plastic packages, having a pouring element (1) with a circumferential flange (2) for fastening to the package (P) and a neck (3) for pouring, as well as a cutting element (4), which is arranged inside the neck (3) and has a plurality of teeth (6), which are arranged around the circumference and directed towards the package, and a screw cap (5), the cutting element (4) cutting a pouring opening into the composite film material as a result of a rotational movement of the screw cap (5) when the package (P) is opened for the first time,
characterised in that the teeth (6) of the cutting element (4) have a steep gradient at the tip thereof, a shallower gradient at the flanks thereof, and again a steep gradient at the base thereof.

2. Device according to claim 1,
characterised in that the teeth (6) of the cutting element (4) are arranged directly adjacently to each other, so that the cutting edges thereof touch.

3. Device according to claim 1 or 2,
characterised in that the number of teeth (6) of a cutting element (4) is between 10 and 20, preferably between 15 and 20.

4. Device according to any one of claims 1 to 3,
characterised in that the tooth flanks are formed sharpened (6A, 6B).

5. Device according to any one of claims 1 to 4,
characterised in that the contour of the tooth flanks (6A, 6B) has arcs in the region of the shallow gradient.

6. Device according to any one of claims 1 to 5,
characterised in that the cutting element (4) has a region (7) without teeth.

7. Device according to any one of claims 1 to 6,
characterised in that the tooth flanks (6A, 6B) of each tooth (6) are formed symmetrically.

8. Device according to any one of claims 1 to 7,
characterised in that the tooth flanks (6A, 6B) of each tooth (6) are formed inclined.

9. Device according to any one of claims 1 to 8,
characterised in that the teeth (6) have a low thickness.

10. Device according to claim 9,
characterised in that the teeth are provided with longitudinal ribs for reinforcement.

11. Device according to any one of claims 1 to 10,
characterised in that all the teeth (6) have the same height.

12. Device according to any one of claims 1 to 11,
characterised in that all the teeth (6) have the same geometry.

13. Device according to any one of claims 1 to 12,
characterised in that guiding means are present between the neck (3) and the cutting element (4) in order to guide the cutting element (4).

14. Device according to claim 13,
characterised in that the guiding means are formed as corresponding webs or cams.

15. Device according to claim 13 or 14,
characterised in that the guiding means are formed as corresponding threaded sections.

16. Device according to any one of claims 1 to 15, characterised in that a functional connection between the cutting element (4) and the screw cap (5) is provided by actuation elements (8, 9, 10).
